(19) United States
(12) Patent Application Publication
(10) Pub. No.: US 2009/0228426 A1
(43) Pub. Date: Sep. 10, 2009

(54) PLATFORM FOR CAPTURING KNOWLEDGE

(75) Inventors: Jeffrey J. Bonasso, Pittsburgh, PA (US); Sara Giordano, Bari (IT); Rahul Gupta, Kanpur (IN); Kathryn Marietta-Tondin, Alexandria, AL (US); Janis A. Morariu, Hardy, VA (US); Devang D. Patel, Dublin, CA (US); Amy S. Purdy, Hyde Park, NY (US); Michael Reed, Pflugerville, TX (US); Amy B. Sander Thrasher, Poughkeepsie, NY (US); Antonella Vaccina, Bari (IT)

Correspondence Address: GREENBLUM & BERNSTEIN, P.L.C., 1950 ROLAND CLARKE PLACE, RESTON, VA, 20191, US

(73) Assignee: INTERNATIONAL BUSINESS MACHINES CORPORATION, Armonk, NY (US)

(21) Appl. No.: 12/042,451

(22) Filed: Mar. 5, 2008

(51) Int. Cl. G06N 5/02

(52) U.S. Cl. 706/60

(57) ABSTRACT

A platform used for capturing knowledge. More specifically, a framework configured to capture expert knowledge (e.g., of trained and/or skilled workers) for future instructional purposes (e.g., training of a younger, or less experienced, workforce). The platform comprises a knowledge recorder, instructional design tool, standardized XML, and gaming engine. The knowledge recorder is configured to capture knowledge of a user, which is transferable using a standardized XML format. The instructional design tool is configured to visually model a gaming scenario in order to expose and define logical situations based on the captured knowledge.

### FIELD OF THE INVENTION

The invention generally relates to a system and method for computer systems and, more particularly, the invention relates to a platform used for capturing knowledge.

### BACKGROUND OF THE INVENTION

Currently, many companies are facing a big challenge of loosing talent due to the exodus of the large workforce constituents aged 50 and older who may retire within the next 5 to 10 years. Within the context of current talent management processes and training approaches, it would be impossible to replace this workforce quickly with adequately trained new talent with minimum impact on the business. It is critical to capture and transfer the needed knowledge and skills effectively and efficiently so that the younger, entering workforce can acquire/build the needed competencies and demonstrate the requisite knowledge and skills within a short timeframe.

There are methods and tools in the market that can help with capturing knowledge via defined processes, documentation, and knowledge management databases. And, there are a variety of learning strategies and systems ranging from traditional classroom to e-learning to deliver the knowledge effectively.

Although there is no right or wrong method to solve these challenges, many of the current solutions are time consuming, complex and do not adequately target the younger workforce. For example, manuals are made and stored electronically for the younger workforce to study, but these manuals are difficult to read and understand. Also, such manuals typically do not capture and retain the attention of the trainees. Accordingly, there exists a need in the art to overcome the deficiencies and limitations described hereinabove.

### SUMMARY OF THE INVENTION

In a first aspect of the invention, a platform comprises a knowledge recorder and instructional design tool as well as standardized XML. The knowledge recorder is configured to capture knowledge of an expert, which is transferable using a standardized XML format. The instructional design tool is configured to visually model a gaming scenario in order to expose and define logical situations based on the captured knowledge.

In another aspect of the invention, a system for deploying an application for immersive learning comprises a computer infrastructure. The computer infrastructure is operable to capture knowledge of an expert via the use of templates that have selectable icons. The captured knowledge is transferable via a standardized XML format. The computer infrastructure is also operable to provide a visual model to expose and define logical situations based on the captured knowledge for implementation in a gaming scenario.

In another aspect of the invention, a method for deploying an application for immersive learning comprises providing a computer infrastructure. The computer infrastructure is operable to: capture knowledge of a user and transfer the knowledge to a designer via a standardized XML format; and model a gaming scenario using the standardized XML format to expose and define logical situations based on the captured knowledge.

In another aspect of the invention, a computer program product for capturing knowledge, comprises: a computer readable media; first program instructions to capture knowledge; second program instructions to model a gaming scenario to expose and define logical situations based on the captured knowledge; and third program instructions to build a learning game based on the model and the captured knowledge, wherein the first, second and third program instructions are stored on the computer readable media, and the first and second program instructions are transferable via a standardized XML format which is platform independent.

### BRIEF DESCRIPTION OF THE DRAWINGS

The present invention is described in the detailed description which follows, in reference to the noted plurality of drawings by way of non-limiting examples of exemplary embodiments of the present invention.

FIG. 1 shows an illustrative environment for implementing aspects of the invention;

FIG. 2 shows an implementation of an end to end view of the system and method in accordance with the invention;

FIG. 3 illustratively shows multi-layer models for implementing aspects of the invention;

FIG. 4 illustratively shows an implementation of a Knowledge Recorder in accordance with the invention;

FIG. 5 illustratively shows a high level view of a Knowledge Recorder and various related tools/components in accordance with the invention;

FIG. 6 shows a graphical user interface with a knowledge capturing scenario in accordance with the invention; and

FIG. 7 shows an illustrative usage scenario implementing an aspect of the invention.

### DETAILED DESCRIPTION OF EMBODIMENTS OF THE INVENTION

The invention generally relates to a platform used for capturing knowledge. More specifically, the system and method of the invention includes a framework configured to capture expert knowledge (e.g., of trained and/or skilled workers) for future instructional purposes (e.g., training of a younger, or less experienced, workforce). In embodiments, the framework comprises a Knowledge Recorder, an Instructional Design Tool, a standardized XML Schema (single/multiple player), and an Engine, e.g., gaming engine.

In implementation, the tools encompass a systematic method to expedite the capture of knowledge from experts and disseminate such knowledge in an immersive, interactive and instructional environment. The immersive, interactive and instructional environment is provided by an instructional design of single-player, multi-player, and/or virtual worlds immersive learning games, and a delivery via a variety of gaming engines and platforms that reduces the production time and cost for training. In use, as should be appreciated by those of ordinary skill in the art, the instructional processes of the invention should significantly decrease training time and increase productivity of the less experienced, younger workforce, by teaching such workforce in a manner which is more amenable to their learning style.

Table 1, below, summarizes the generational differences in relevant learning, decision-making, problem-solving, leadership, communication styles, and technology use that have significant influence on effective methods for collaboration and knowledge transfer across generations.

TABLE 1

| | Traditionalist | Boomer | Gen X | Gen Y |
|---|---|---|---|---|
| | Age 61-84 | Age 42-60 | Age 26-41 | Age 18-25 |
| Training | The hard way | Too much | Required to | Continuous & |
| | | and I'll | keep me | expected |
| | | leave | | |
| Learning style | Classroom | Facilitated | Independent | Collaborative & |
| | | | | networked |
| Communication | Top down | Guarded | Hub & Spoke | Collaborative |
| style | | | | |
| Problem-solving | Hierarchical | Horizontal | Independent | Collaborative |
| Decision-making | Seeks Approval | Team | Team | Team decided |
| | | informed | included | |
| Leadership style | Command & | Get out of | Coach | Partner |
| | control | the way | | |
| Feedback | No news is | Once per | Weekly/Daily | On demand |
| | good news | year | | |
| Technology use | Uncomfortable | Unsure | Unable to | Unfathomable if not |
| | | | work | provided |
| | | | without it | |
| Job changing | Unwise | Sets me | Necessary | Part of my daily |
| | | back | | routine |

(See, Lancaster, L. C. and Stillman, D. When Generations Collide: Who They Are. Why They Clash. How to Solve the Generational Puzzle at Work. Wheaton, Ill. Harper Business, 2003.)

Research shows that Generation “Y” (e.g., age 18-25) prefers an immersive, game-based collaborative environment where they can interact via 3D characters in realistic role-play scenarios. Leveraging and creating immersive gaming environments to facilitate knowledge transfer and effective learning using current processes, people resources, and tools, however, has been found to be cost and time prohibitive. However, the present invention has addressed these issues by providing:
the experienced knowledge worker (e.g., expert) with a streamlined process and tools to capture and transfer the needed knowledge and skills to effectively train the novice knowledge worker (e.g., less experienced worker); and
the novice knowledge worker with an efficient method of acquiring needed knowledge and skills quickly with a collaborative, on demand, immersive game-based learning system.

### System Environment

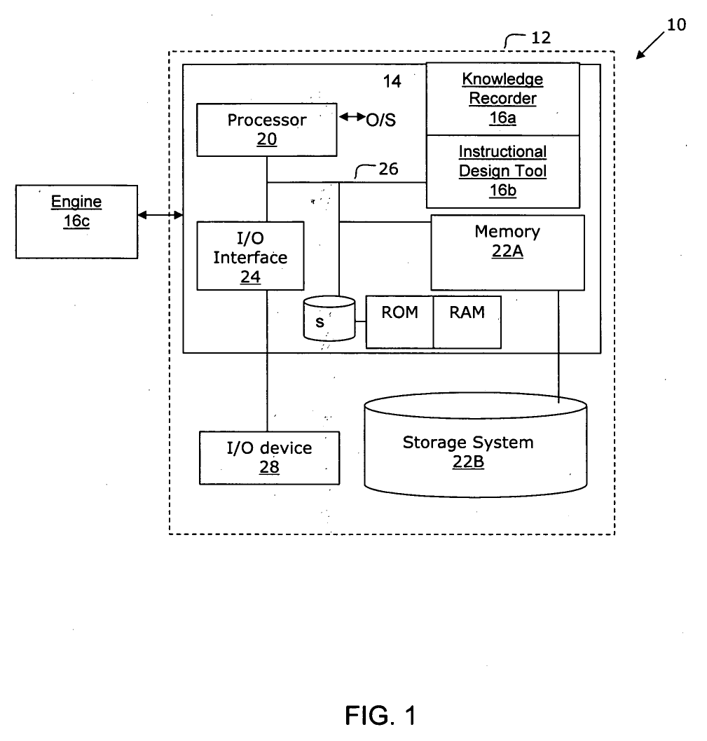

FIG. 1 shows an illustrative environment 10 for managing the processes in accordance with the invention. To this extent, the environment 10 includes a computer infrastructure 12 that can perform the processes described herein. In particular, the computer infrastructure 12 includes a computing device 14 that comprises a Knowledge Recorder 16a and an Instructional Design Tool 16b, both implementing and using a standardized XML schema. The standard XML schema makes it possible to communicate efficiently and effectively across the different tools and platforms in accordance with the invention.

In further embodiments, an Engine 14c and more specifically, a Gaming Engine 14c, can be either internal or external to the computing device 14. The Engine 14c is configured to receive the standardized XML schema in order to create an interactive instructional gaming environment used for instructional and knowledge transfer purposes. In embodiments, the Engine 14c is platform dependent.

The Knowledge Recorder 16a and Instructional Design Tool 16b make the computing device 14 operable to expedite the capture of knowledge from experts, as well as significantly decrease training time and increase productivity of the less experienced, younger workforce. Simply, this is done by teaching such workforce in a manner which is more amenable to their learning style, e.g., within an immersive gaming environment. The Knowledge Recorder 16a includes a Graphical User Interface (GUI) (e.g., an I/O device/resource 28) that allows an expert and instructional designer to capture process flow/series of task and their relationship, without requiring such users to have an understanding of the underlying XML model. As such, the Knowledge Recorder 16a acts as a knowledge capturing tool that allows subject matter experts (SMEs) to record their knowledge, either by themselves or with some external assistance, which is then used as part of the instructional gaming design and development, in accordance with the invention.

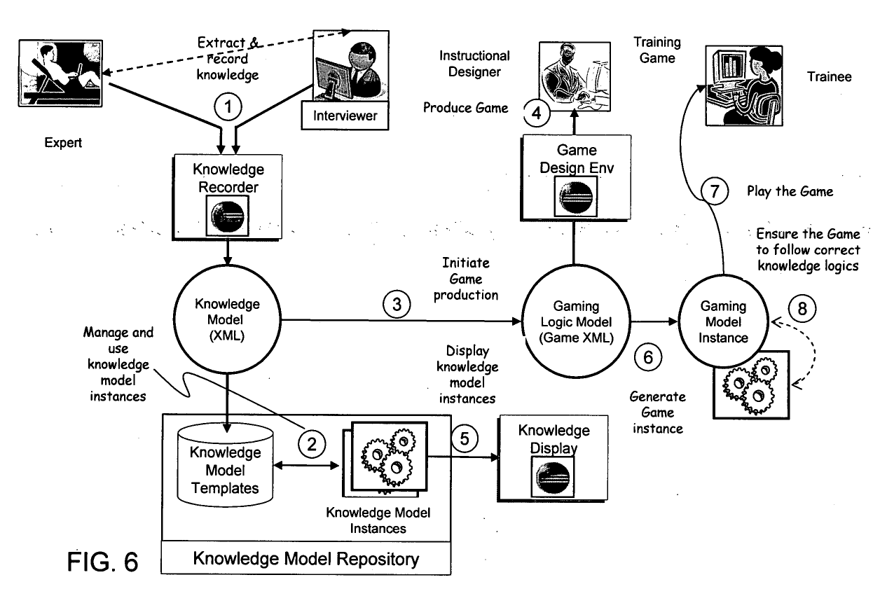

In embodiments, the Knowledge Recorder 16a may include a set of generic templates for conducting expert interviews (See, e.g., FIG. 6), which can later be transferable to the game designers (via the standardized XML). These templates, which are customizable, may capture and record (document) workforce scenarios based on a decision tree, e.g., hierarchical, format. It is also possible to embed external resources, e.g., presentations, websites and spreadsheets, into the Knowledge Recorder 16a at appropriate locations in a particular scenario. In embodiments, the Knowledge Recorder 16a is designed using Eclipse™ technology, and is platform independent. (Eclipse is a trademark of International Business Machines Corp. in the U.S. and throughout the world.)

The Instructional Design Tool 16b is configured to permit an instructional designer to visually model a gaming scenario in order to expose and define logical situations “IN GAME”. The instructional designer will use the knowledge of the expert when designing the visual model, e.g., adding media, graphics, etc. In embodiments, the Instructional Design Tool 16b is an eclipse-based RCP plug-in and is platform independent. The Design Tool 16b also uses the standardized XML format.

More specifically, in implementation, the Instructional Design Tool 16b prepares a standardized XML feed for a gaming engine layer. The gaming engine layer is, in embodiments, designed to use the standardized XML-based feed to prepare the Gaming Engine 16c to deliver the immersive learning and gaming experience in accordance with the invention.

The computing device 14 further includes a processor 20, a memory 22A, an input/output (I/O) interface 24, and a bus 26. The memory 22A can include local memory employed during actual execution of program code, bulk storage, and cache memories which provide temporary storage of at least some program code in order to reduce the number of times code must be retrieved from bulk storage during execution. Further, the computing device 14 is in communication with the external I/O device/resource 28 and a storage system 22B. In the present implementation, the I/O device 28 can be a graphical user interface, which provides the expert and/or instructional designer the means to capture process flow/series of task and its relationship.

In general, the processor 20 executes computer program code, which is stored in memory 22A and/or storage system 22B. While executing computer program code, the processor 20 can read and/or write data to/from memory 22A, storage system 22B, and/or I/O interface 24. The bus 26 provides a communications link between each of the components in the computing device 14.

The computing device 14 can comprise any general purpose computing article of manufacture capable of executing computer program code installed thereon (e.g., a personal computer, server, handheld device, etc.). However, it is understood that the computing device 14 is only representative of various possible equivalent-computing devices that may perform the processes described herein. To this extent, in embodiments, the functionality provided by computing device 14 can be implemented by a computing article of manufacture that includes any combination of general and/or specific purpose hardware and/or computer program code. In each embodiment, the program code and hardware can be created using standard programming and engineering techniques, respectively.

Similarly, the computer infrastructure 12 is only illustrative of various types of computer infrastructures for implementing the invention. For example, in embodiments, the computer infrastructure 12 comprises two or more computing devices (e.g., a server cluster) that communicate over any type of communications link, such as a network, a shared memory, or the like, to perform the process described herein. For example, each computing device may include a single tool (e.g., Knowledge Recorder, Instructional Design Tool and Engine), that is configured to communicate with one another over an Intranet. Further, while performing the processes described herein, one or more computing devices in the computer infrastructure 12 can communicate with one or more other computing devices external to computer infrastructure 12 using any type of communications link. The communications link can comprise any combination of wired and/or wireless links; any combination of one or more types of networks (e.g., the Internet, a wide area network, a local area network, a virtual private network, etc.); and/or utilize any combination of transmission techniques and protocols.

In embodiments, a service provider, such as a Solution Integrator, could offer to perform the processes described herein. In this case, the service provider can create, maintain, deploy, support, etc., a computer infrastructure (e.g., computing infrastructure of FIG. 1) that performs the process steps of the invention for one or more customers. In return, the service provider can receive payment from the customer(s) under a subscription and/or fee agreement.

### Exemplary Implementation of the System of the Invention

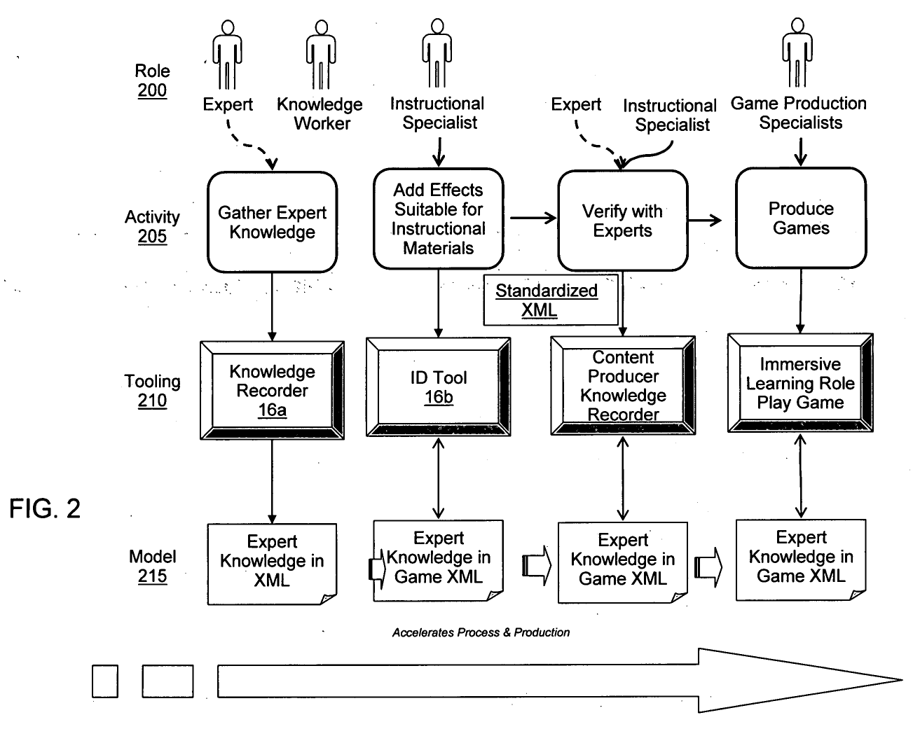

FIG. 2 shows an implementation of an end to end view of the system in accordance with the invention. FIG. 2 also illustratively shows a high-level swim-lane diagram, implementing processes in accordance with the invention using, for example, the infrastructure shown in FIG. 1. In particular, FIG. 2 shows the specific roles (e.g., users) (200), activities (205), tooling (210) and model (215) for implementing the system and method of the invention.

The roles 200 include: an expert and/or knowledge worker, an instructional designer, expert and/or instructional designer and game production specialist. It should be understood that the above noted “users” are only illustrative of the roles used in implementing the invention and that some of the roles (users) can be combined and/or eliminated. For example, the expert and the knowledge worker can be the same user. Also, in embodiments, it should be understood that some of the activities can be combined such as, for example, the adding of effects suitable for instructional materials and the verification with the expert.

As to the activities 205, in a first of the processes, the system and method of the invention gathers the expert knowledge of the expert and/or knowledge worker. The gathering of the expert knowledge is accomplished through a set of templates using the Knowledge Recorder 16a. By way of example, a set of customizable templates can request, capture and document specific work-related knowledge of the expert such as different negotiation scenarios, entering information in a database, etc. in a structured environment. And, using a hierarchical structure, the expert can provide a process from initiation to conclusion of the task, with different scenarios at each stage of the task as discussed further herein.

The captured knowledge is saved in a standardized XML schema. In embodiments, the XML schema allows for efficient communication across the different tools, i.e., Knowledge Recorder, Instructional Design Tool and Engine. The standardized XML schema can contain:
Defined Objects for an immersive experience. These objects can include master timeline, places with attributes and characters, all of which should be understood by those of skill in the art. The characters can include, for example, timelines, conversations (with other characters for the purpose of instruction, e.g., a negotiation) and attributes of the characters (e.g., clothing, gender, etc.); and
Assessment against goals. These assessments can include timeline, interactions and attributes, to name a few.

The Instructional Design Tool 1 6b allows the instructional designer to incorporate media and graphics with the recorded expert knowledge. More specifically, the Instructional Design Tool 16b allows the instructional designer to visually model the immersive learning environment by adding scenario-specific details. These scenario-specific details can include characters, places, objects, interactions, and events, all of which are associated with a specific training scenario using the recorded information of the expert. These scenario-specific details with the recorded knowledge are then provided into an instructionally sound learning environment without having to spend as much time on design as he/she typically would with manual interview and documentation methods.

Similar to above, the scenario-specific details can be saved in a standardized XML schema. As the scenario-specific details are saved in a standardized XML schema, the Instructional Designer Tool 16b can automate an XML feed for the gaming engine layer, which translates this feed and prepares a gaming engine component. The instructional elements are transferred into a production game using, for example, IBM™ Content Producer™ or Flash or 3D virtual environment. (IBM^{and} Content Producer are trademarks of International Business Machines Corp. in the U.S. and throughout the world.) Also, in embodiments, the expert and instructional designer can collaborate with one another in order to verify the accuracy of the scenario-specific details. The verification process can be implemented using the IBM™ Content Producer™.

The scenario-specific details with the recorded knowledge can be provided to any known gaming engine 16c for building the highly interactive immersive role-play game, which is designed to engage novice learners in rapid knowledge and skill development via effective gaming strategies and technologies. As noted above, the gaming engine 16c is provided with the requisite information via a feed for the gaming engine layer, using the standard XML-based feed to prepare the gaming engine to deliver the immersive learning and gaming experience.

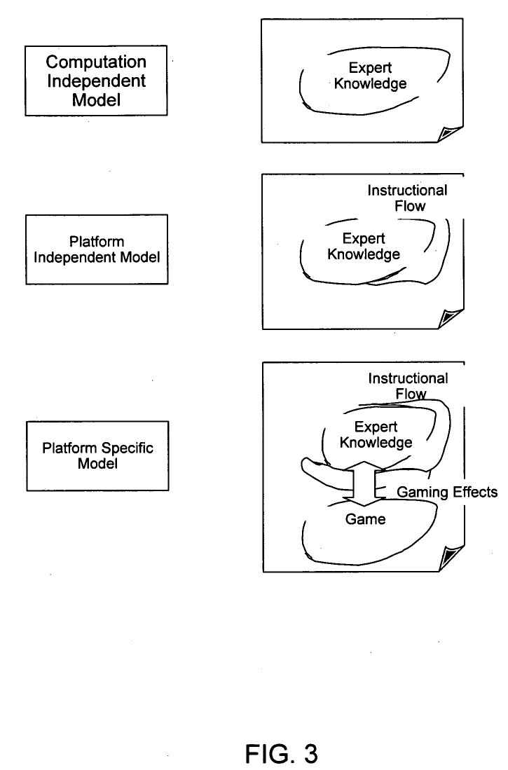

FIG. 3 illustratively shows multi-layer models for implementing aspects of the invention. More specifically, FIG. 3 shows a computational independent model, platform independent model and platform specific model for implementing aspects of the invention. The computational independent model, in embodiments, is an expert knowledge model expressed in a standardized XML format using, for example, decision tree and flow modeling techniques. The computational independent model, in embodiments, can also use other modeling elements. Also, as discussed above, the computational independent model (based on the knowledge captured by the Knowledge Recorder) may use templates to capture and record (document) workforce scenarios. The templates can record and document knowledge using decision tree modeling, e.g., hierarchical format, as well as incorporate embedded external resources, e.g., presentations, spreadsheets, websites, etc.

The platform independent model includes the expert knowledge model augmented by an instructional flow and other necessary attributes to capture required rich media data. As its name implies, the platform independent model uses a common language for use in any platform. The platform independent model is implemented using the Independent Design Tool 16b. The platform specific model, on the other hand, is specific to gaming platforms. The platform specific model takes the expert knowledge model with the instructional flow and enriches such data with gaming related data such as special gaming effects and games.

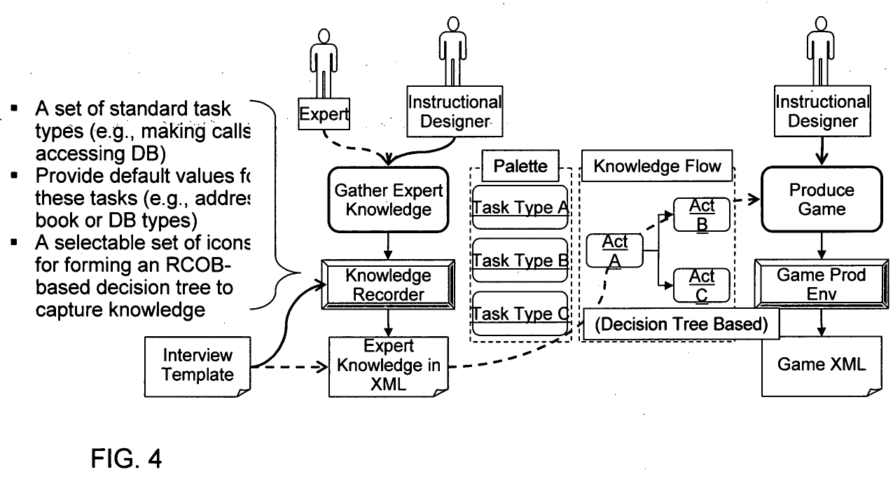

FIG. 4 illustratively shows an implementation of a Knowledge Recorder in accordance with the invention. As discussed with reference to FIG. 2, the Knowledge Recorder 16a captures and records knowledge from the expert (and instructional designer). This can be provided by a set of generic templates for conducting expert interviews, which may be designed by the instructional designer for various different work-related scenarios. These work related scenarios may be related to any number of different tasks such as, for example, different types of negotiations, procurement of supplies, etc. The tool environment (e.g., use of the templates) allows the expert's knowledge to be recorded without requiring a deep understanding of the underlying XML model. For example, a GUI interface can be used in order to obtain the information from the expert.

The templates for various different work-related scenarios are represented, in the illustrative implementation of FIG. 4, by palette 400. The palette 400 includes different templates for different types of activities such as, for example, Task Type “A”, Task Type “B”, and Task Type “C”. These task types may represent, for example, making calls, accessing a database, procurement and/or negotiation scenarios, etc. The Knowledge Recorder 16a may provide default values for these tasks, as well as a selectable set of icons for forming decision trees to capture the knowledge of the expert (FIG. 6). In embodiments, the decision tree may be a Rapid Client On Board (RCOB) based decision tree. RCOB based decision tree tools are well known in the art and, as such, a further description of such is not necessary.

In use, the expert can be brought through different types of activities via a knowledge flow. The knowledge flow, in embodiments, is a decision tree based structure, which allows the expert to account for various scenarios, based on a previous decision. So, for example, if the expert selected act “A”, the decision tree would automatically bring the expert to act “B” and act “C”. At this stage, the expert can select either act “B” or act “C”. Those of skill in the art should understand that selecting act “B” may result in a decision flow of different acts compared to the selection of act “C”. The recorded expert knowledge, in a standardized XML format, can be transferable to the game designer for preparing the immersive learning and gaming experience.

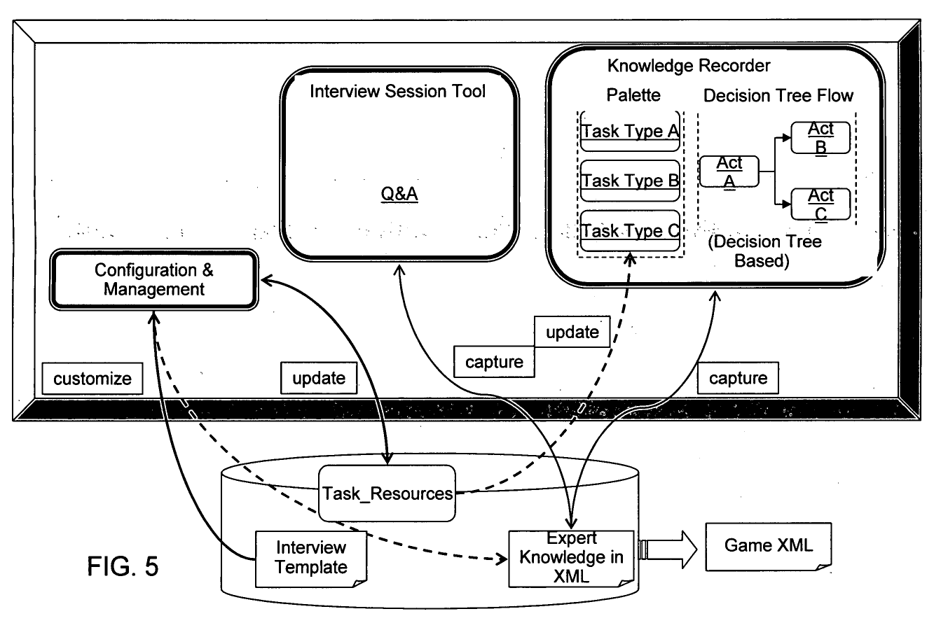

FIG. 5 illustratively shows a high level view of a Knowledge Recorder and various related tools/components in accordance with the invention. Specifically, the Knowledge Recorder 16a includes a configuration and management component 500. The configuration and management component 500 allows the service provider (e.g., instructional designer) to manage the tools and processes of the invention. For example, using the configuration and management component 500, the service provider can load, update, and/or customize the templates, or manage other components and/or interfaces etc. related to the system of the invention. The templates can be loaded and updated from and saved to a database (storage system 28B of FIG. 1).

The Knowledge Recorder 16a also includes an interview session tool 505. The interview session tool 505 builds the tasks (displays the templates and decision tree), and maintains consistency and persistence of the templates, for example. More specifically, in embodiments, the interview session tool 505 displays the templates and builds the decision tree, based on the interactions with the expert (e.g., captured expert knowledge). The interview session tool 505 also captures the knowledge of the expert and saves such knowledge, via a standard XML format, in the database. The expert can also embed external resources, e.g., power point presentations, spreadsheets, media, etc. into the templates using the interview session tool 505. Those of skill in the art should recognize that the database could store the different question and answer decision trees and the embedded external resources in accordance with the invention. The recorded information is then provided to a game engine, via the standardized XML schema.

FIG. 6 shows a graphical user interface with a knowledge-capturing scenario in accordance with the invention. More specifically, FIG. 6 shows a negotiation scenario, using a template based on a decision tree format. In this specific illustrative example, an expert would record his/her knowledge using the selectable set of icons 600. The selectable set of icons 600 includes different scenarios for a task, which may be dependent on a previous selection.

By way of illustration, in the example shown, the expert logs into the system of the invention by providing user a name and password. Once logged in, the graphical user interface will display a selectable icon, e.g., “Select Scenario Single” icon, prompting the expert to select a specific template associated with a specific task, e.g., negotiation scenario. The expert can then select a scenario from the “Select Scenario Single” icon. In this example, the expert selected Negotiation Scenario, which result in the display of the “Check Email Single” icon. (Thus far, this is a normal task flow.)

As shown in this example, the “Check Email Single” icon includes several different scenarios. For example, the “Check Email Single” icon includes “Result 1”, “Result 2”, “Result 3” and “Result 4”. Each of these selections will result in different scenarios for the task, dependent on the selection. For example, the selection of “Result 1” will prompt the system to display a different icon than the selection of “Result 2”. In either or any scenario, the system of the invention allows the user to manually enter information into the selectable icons by selecting, for example, a task definition, which includes feasible actions. This will also allow the expert to embed an external resource into the tool. As discussed above, the selection of the icons will be converted into a standardized XML form, thus allowing additional flexibility in building the immersive learning and gaming experience.

### Exemplary Processes in Accordance with the Invention

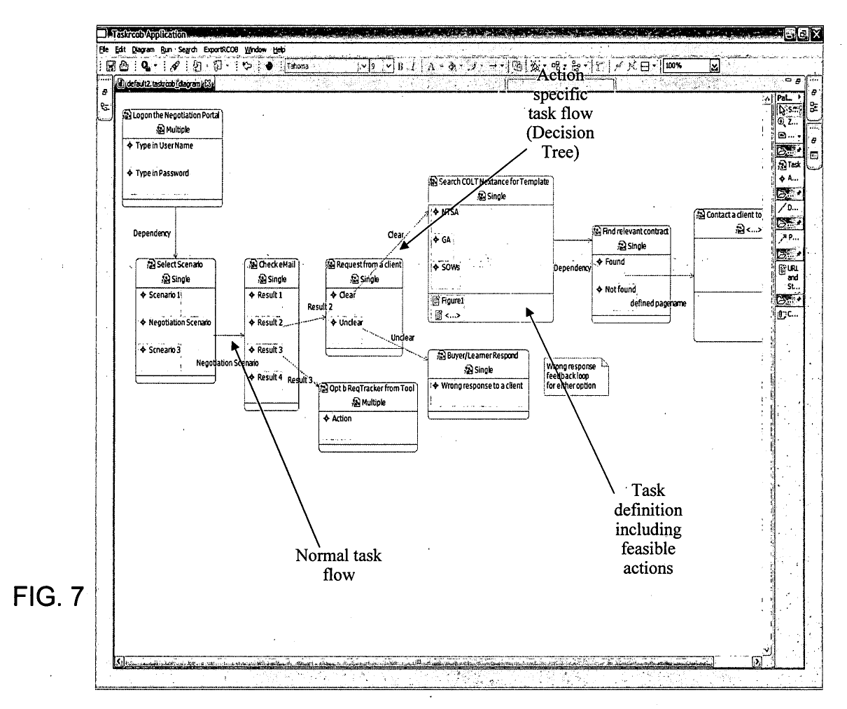

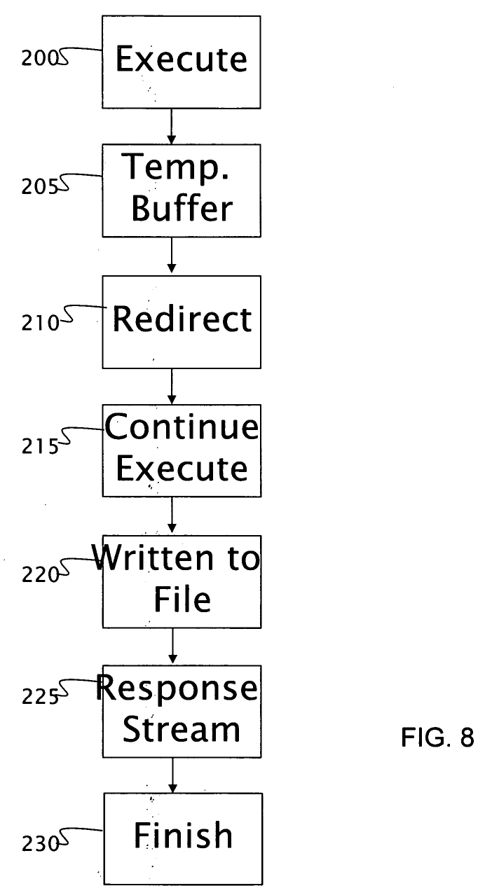

FIG. 7 shows an illustrative usage scenario implementing the processes of the invention. FIG. 7 may equally represent a high-level block diagram of components of the invention implementing the steps thereof. The processes of FIG. 7 may be implemented on computer program code in combination with the appropriate hardware as described with reference to FIG. 1. This computer program code may be stored on storage media such as a diskette, hard disk, CD-ROM, DVD-ROM or tape, as well as a memory storage device or collection of memory storage devices such as read-only memory (ROM) or random access memory (RAM) (see, e.g., element 22B). Additionally, the computer program code can be transferred to a workstation over the Internet or some other type of network.

The invention can take the form of an entirely hardware embodiment or an embodiment containing both hardware and software elements (any of which is referred generally as “file management program”). The hardware and software elements include a computer infrastructure configured to implement the functionality of the present invention. The computer infrastructure may take the form, for example, of the environment of FIG. 1. The software elements may be firmware, resident software, microcode, etc. Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

Referring to FIG. 7, the Knowledge Recorder extracts and records the knowledge of the expert. As discussed above, the extraction and recordation of the knowledge can be accomplished using templates via selectable icons on a graphical user interface. The knowledge model is saved in a standardized XML format. The knowledge model templates and knowledge model instances can be saved and managed from a database, and displayed via an I/O device (knowledge display).

The standardized XML model, e.g., captured knowledge content, is provided to an instructional designer to design the game environment. At this stage, the instructional designer can provide (build) media and graphics specific to the scenario. This may include the addition of special effects, etc. which would make the immersive learning and gaming experience more interesting to the trainee. The workflow and graphics can then be provided to the gaming model instance, e.g., game engine, via the standardized XML feed. At this stage, the game designer can build the immersive learning game using the workflow and graphics. At this or an earlier stage, a verification process can be provided to ensure that the game is to follow the correct knowledge logic. Once the game is built, the trainee can play the game in order to learn the knowledge of the more experienced worker.

While the invention has been described in terms of embodiments, those skilled in the art will recognize that the invention can be practiced with modifications and in the spirit and scope of the appended claims.

What is claimed is:

1. A platform comprising:
a knowledge recorder configured to capture knowledge of a user, wherein the captured knowledge is transferable using a standardized XML format; and
an instructional design tool configured to visually model a gaming scenario in order to expose and define logical situations based on the captured knowledge.

2. The platform of claim 1, wherein the instructional design tool is configured to transfer the visual model using the standardized XML format, which is fed to a gaming engine.

3. The platform of claim 1, wherein the knowledge recorder includes a Graphical User Interface that is configured to allow the user to capture process flow/series of task and their relationship, without an understanding of an underlying XML model.

4. The platform of claim 1, wherein the knowledge recorder includes a set of generic templates for conducting interviews which are transferable to the instructional design tool via the standardized XML format.

5. The platform of claim 4, wherein the templates are customizable and include selectable icons presented in a decision tree format.

6. The platform of claim 5, wherein the knowledge recorder accepts external embedded resources.

7. The platform of claim 1, wherein the knowledge recorder and instructional design tool are platform independent.

8. The platform of claim 1, wherein the instructional design tool is an eclipse-based RCP plug-in.

9. The platform of claim 1, wherein the knowledge recorder provides the captured knowledge to the instructional design tool in a standardized XML format.

10. The platform of claim 1, wherein the platform is created on a computer infrastructure.

11. The platform of claim 1, wherein the standardized XML format includes defined objects and assessment against goals.

12. A system for deploying an application for immersive learning comprising a computer infrastructure being operable to:
capture knowledge of a user via the use of templates that have selectable icons, the captured knowledge is transferable via a standardized XML format; and
provide a visual model to expose and define logical situations based on the captured knowledge for implementation in a gaming scenario.

13. The system of claim 12, wherein the computer infrastructure is at least one of maintained, deployed, supported and created by a service provider for a fee.

14. The system of claim 12, wherein the selectable icons are dependent on a selection of the user.

15. The system of claim 12, wherein the selectable icons are based on a hierarchical format.

16. The system of claim 12, wherein the visual model is transferable to a gaming model layer via the standardized XML format.

17. The system of claim 12, wherein the computer infrastructure is operable to capture process flow/series of task and their relationship, without an understanding of an underlying XML model.

18. The system of claim 12, wherein the capturing of the knowledge and providing of the visual model are platform independent.

19. The system of claim 12, wherein the computer infrastructure is operable to use the captured knowledge and visual model to create a gaming environment, via a standardized XML feed using the standardized XML format.

20. A method for deploying an application for immersive learning comprising:
providing a computer infrastructure being operable to:
capture knowledge of a user and transfer the knowledge to a designer via a standardized XML format; and
model a gaming scenario using the standardized XML format to expose and define logical situations based on the captured knowledge.

21. The method of claim 20, wherein the computer infrastructure is at least one of maintained, deployed, supported and created by a service provider.

22. The method of claim 20, wherein the computer infrastructure is operable to capture the knowledge by use of the selectable icons which are dependent on a selection of the user.

23. The method of claim 22, wherein the selectable icons are based on a hierarchical format.

24. The method of claim 20, wherein the model is transferable to a gaming model layer via the standardized XML format.

25. A computer program product for capturing knowledge, the computer program product comprising:
a computer readable media;
first program instructions to capture knowledge;
second program instructions to model a gaming scenario to expose and define logical situations based on the captured knowledge; and
third program instructions to build a learning game based on the model and the captured knowledge, wherein
the first, second and third program instructions are stored on the computer readable media, and
the first and second program instructions are transferable via a standardized XML format, which is platform independent.
